(19) United States
(12) Patent Application Publication
(10) Pub. No.: US 2008/0222943 A1
(43) Pub. Date: Sep. 18, 2008

(54) Method for Controlling Bark Beetle Populations by Controlling Bark Beetle Antagonists

(75) Inventors: Thomas Zuhlke, Rodersheim-Gronau (DE); Michael Mueller, Zossen (DE)

Correspondence Address: BRINKS, HOFER, GILSON & LIONE, 2801 SLATER ROAD, SUITE 120, MORRISVILLE, NC, 27560, US

(73) Assignee: BASF Aktiengesellschaft, Ludwig (DE)

(21) Appl. No.: 11/994,703

(22) PCT Filed: Jul. 6, 2006
(86) PCT No.: PCT/EP2006/063949

§ 371 Date: Jan. 4, 2008

(30) Foreign Application Priority Data
Jul. 7, 2005 (DE) 10 2005 031 874.6

(51) Int. Cl. A01M 99/00

(52) U.S. Cl. 43/132.1

(57) ABSTRACT

The invention relates to a natural method for controlling bark beetle populations by controlling the predators of bark beetle. Said method comprises aggregating bark beetle predators in the natural environment of the bark beetles by applying a chemical attractant effecting attraction of predators of the bark beetles to be controlled in those locations where a control of the bark beetle population is desired.

The present invention relates to a near-natural method of controlling bark-beetle populations by managing bark-beetle predators.

Bark beetles (Scolytidae) can be harmful insects in forests. The recent mass appearances of bark beetles following the storms “Wiebke” in 1990 and “Lothar” in 2000, producing respectively 14.8 and 29 million m³ of windthrow and windbreak and also respectively 9.6 and (through 2003) about 2.8 million m³ of calamity wood due to bark beetles, in Germany alone are striking examples. Studies in the Harz National Park have demonstrated that 70% of the mature specimens in non-managed forests of spruce (Picea abies (L.) Karst.) died within five years as the result of the mass appearances of the Norway spruce engraver (Ips typographus L.). What is more, the spruces were killed even in multi-species stands of spruce and beech (Fagus sylvatica L.).

Aspects of conventional forestal practice, such as providing dead timber in the forest, which per se is ecologically desirable, are also critical with regard to the appearance of bark beetles and the risks which this entails. The reason is that, when dead timber is provided, the timber undergoes a phase in which it is suitable for potentially harmful bark- and timber-breeding bark beetles. This is why the provision of dead timber, in particular larger-sized dead timber, entails problems in coniferous species, in particular spruce (Picea abies (L.) Karst.) and larches (Larix spp.).

Bark beetles have also proved problem pests in the provision of undressed timber. This is because present-day utilization and delivery of undressed timber usually dispenses with storage in the wood-processing plants, and the undressed timber remains in the forest until shortly before it is processed. Since, depending on the processing requirements, logging takes place all year round, nothing prevents the timber from attack by bark- and timber-breeding insects, in particular bark beetles. This is why a preventative or indeed routine treatment with unselective insecticides, for example with active ingredients from the pyrethroid group, is carried out in more valuable assortments, such as high-grade timber, saw logs and timber intended for moldings, since attack by bark-breeding bark beetles alone may lead to the timber losing its value.

The monitoring of bark-beetle populations is currently based on the aggregation of bark beetles by means of species-specific aggregation pheromones. The latter serve to aggregate the bark beetles of the species associated with the pheromone in traps for the purposes of monitoring or on trap trees or other natural hatching materials for control purposes. However, existing findings reveal that trap catches constitute a population reduction in the bark beetles which is insufficient as a countermeasure. The trap-tree and trap-brush methods, in turn, involve a great deal of materials, are very laborious and also frequently involve the use of unselective crop protection agents.

There is therefore a need for providing a method of controlling bark-beetle populations which is simple to carry out and, if possible, does not involve the use of insecticides.

Surprisingly, it has been found that it is possible to aggregate the bark-beetle predators (which feed on them) by applying suitable attractants so that the aggregation of these predators results in a sufficient effect of efficiently preventing, or reducing, the build-up of substantial bark beetle populations.

The present invention therefore relates to a method for controlling populations of bark beetles (Scolytidae) comprising the aggregation of bark-beetle predators in the habitat of the bark beetles, by applying, at the locations where control of the bark-beetle population is to be achieved, at least one attractant which brings about attraction of predators of the bark beetles to be controlled.

Targeted selection of the attractants additionally makes it possible to avoid attracting, with this attractant, those bark beetles which are native to the habitat. The appearance of the bark beetles at the trees or undressed timber to be protected is only the result of the attraction by the constituents of the trees themselves, or the untreated timber itself.

The method according to the invention can be carried out in a simple manner since, as opposed to the known methods of controlling bark-beetle populations, it is only required to apply suitable attractants, while traps, trap timber or trap piles can be dispensed with. Moreover, the use of insecticides is not necessary since an effective reduction of the bark-beetle population in question is achieved by the aggregated populations of the predators. This is why the method according to the invention can be employed in particular in protected areas and in certified silviculture. _p With regard to the bark-beetle population, the term “control” here and hereinbelow refers both to the prevention of the build-up of substantial bark-beetle populations and to their reduction or destruction.

Examples of typical bark-beetle species whose populations can be controlled by the method according to the invention are

1. the following species, which are found on Picea species, in particular on spruce (Picea abies (L.) Karst.):
eight-dentated bark beetle or Norway spruce engraver (Ips typographus L.) and
six-dentated bark beetle or spruce wood engraver (Pityogenes chalcographus L.);

2. the following species, which is found on larches (Larix spp.):
larger pine scotytid (Ips cembrae Heer);

3. the following species, which are found on pines (Pinus spp.), in particular on Scotch pine (Pinus sylvestris L.):
Ips sexdentatus Boern.,
sharp-dentated bark beetle (Ips acuminatus Gyll.),
two-toothed pine beetle (Pityogenes bidentatus Hrbst.);
pine-shoot beetle (Tomicus spp., for example Tomicus piniperda and Tomicus minor),
Dendroctonus spp. (for example Dendroctonus frontalis Z. and Dendroctonus rufipenuis),
Ips ssp (Ips avulsus, Ips grandicollis, Ips calligraphus and Ips pin);

4. the following bark beetles which are found on coniferous or deciduous trees and their undressed timber: for example
striped ambrosia beetle (Xyloterus lineatus Ol.),
Xyloterus domesticus L.;

5. the following bark-beetle species which are found on deciduous trees: for example
Traphrorychus bicolor Hbst.,
Scolytus intricatus Rtzb.

The bark-beetle predators to be attracted are typically those beetles (Coleoptera) which are known to predate on bark beetles.

The typical bark-beetle predators include beetle species from the family of the checkered beetles (Cleridae), in particular from the genus Thanasimus, for example the species Thanasimus formicarius L., Thanasimus rufipes Brahm., Thanasimus substriatus, Thanasimus dubius, Thanasimus undatulus and Thanasimus mutillarius F., but also species from the genera Opilio, Tillus and Corynetes. Other known bark-beetle predators belong for example to the families Ostomidae—a typical species being Nemosoma elongatum L., Staphilinidae and Rhizophagidae. Beetles of these families can likewise be aggregated using the method according to the invention. In most cases, both the imagos and the larvae of the abovementioned beetles are predators. The abovementioned beetle species are widely distributed and exhibit good host adaptation, high foraging and predation capacity and high and adaptive production rate. Despite good host adaptation, these predators are also capable of utilizing a number of other hosts, even on other tree species, i.e. in completely different habitats, including dead timber.

A selection of relevant bark beetles, their primary host trees and one of their important predators can be found in Table 1.

TABLE 1
Selected bark beetles, their primary host tree species and one of their
important predators

| Bark-beetle species | Primary host tree | Predator |
|---|---|---|
| Ips typographus | spruce | Thanasimus formicarius |
| Pityogenes chalcographus | spruce | Nemosoma elongatum L |
| Large larch bark beetle | larch | Thanasimus formicarius |
| Ips stenographus | pine | Thanasimus formicarius |
| Sharp-dentated bark beetle | pine | Thanasimus formicarius |
| Two-toothed pine beetle | pine | Nemosoma elongatum L |
| Taphrorychus bicolor | beech | Nemosoma elongatum L |
| Pine-shoot beetle (Tomicus | spruce | Thanasimus formicarius |
| spp.) | | |
| Dendroctonus spp. | Pinus spp. | Thanasimus dubius |
| Ips grandicollis | Pinus spp. | Thanasimus dubius |
| Ips avulsus | Pinus spp. | Thanasimus dubius |
| Ips calligraphus | Pinus spp. | Thanasimus dubius |
| Ips pin | Pinus spp. | Thanasimus dubius |

Attractants (pheromones) of the bark beetles which bring about an aggregation of the abovementioned predators because they are also used by the predators as kairomones are, in principle, known from the specialist literature. An overview is found, for example, in “The Pherobase—Database of Insect Pheromones and Semiochemicals” [http://www.pherobase.com]. Here, the term “attractants” comprises not only pure substances which act as attractants, but also mixtures of a variety of substances which act as attractants, known as attractant or pheromone bouquets.

In particular, the attractant or attractant bouquet in the method according to the invention comprises at least one of the following components, including all of the isomers, unless otherwise specified:
ipsdienol=(2-methyl-6-methylene-2,7-octadien-4-ol),
alpha-pinene=(2,6,6-trimethylbicyclo[3.1.1]hept-2-ene),
cis-verbenol=(1S,2S,5S)-4,6,6-trimethylbicyclo[3.1.1]hept-3-en-2-ol),
lineatin=(3,3,7-trimethyl-2,9-dioxatricyclo[3.3.1.0_{4,7}]nonane)
lanierone=2-hydroxy-4,4,6-trimethyl-2,5-cyclohexadien-1-one
frontalin=1,5-dimethyl-6,8-dioxabicyclo[3.2.1]octane
seudenol=3-methylcyclohex-2-enol,
3R,6R-vittatol=((3R,6R)-3-hydroxy-2,2,6-trimethyltetrahydropyran),
chalcogran=2-ethyl-1,6-dioxaspiro[4,4]nonane or
bicolorin=(1S,2R,5R)-2-ethyl-1,5-dimethyl-6,8-dioxabicyclo(3.2.1)octane.

In addition, the attractant bouquets may also comprise one or more further attractant substances such as
methylbutenol,
methylbutynol,
ipsenol=(2-methyl-6-methylene-7-octen-4-ol),
2-phenylethanol,
3R,6R-vittatol=((3R,6R)-3-hydroxy-2,2,6-trimethyltetrahydropyran),
amitinol=(trans-2-methyl-6-methylene-3,7-octadien-2-ol) or
grandisol=(cis-1-methyl-2-(1-methylethenyl)cyclobutanethanol).

These attractants, or attractant bouquets, are known to be able to attract bark-beetle predators and specifically beetles of the genus Nemosoma and beetles of the genus Thanasimus and thus to be suitable for aggregating these beetles.

Particularly suitable for attracting Thanasimus species is an attractant, or attractant bouquet, which comprises at least one of the following substances: ipsdienol, α-pinene, lineatin, seudenol, lanierone, frontalin and/or cis-verbenol. In addition, these attractant bouquets may also comprise one or more, for example 1, 2 or 3 further attractant substances such as methylbutenol, methylbutynol, ipsenol, 2-phenylethanol or amitinol.

For example the following attractants and attractant bouquets a.1 to a.4 are suitable for attracting Thanasimus formicarius:
a.1 ipsdienol+cis-verbenol+methylbutenol (Pheroprax®),
a.2 ipsdienol+2-phenylethanol+α-pinene (Sexowit®),
a.3 (+)-ipsdienol+(−)-ipsenol,
a.4 ipsdienol+methylbutenol+ipsenol+amitinol (Cembräwit®).

For example the following attractant bouquets are suitable for attracting the Thanasimus species Thanasimus dubius F.:
a.5 α-pinene+ipsdienol+lanierone,
a.6 seudenol+α-pinene,
a.7 ipsdienol, in particular an enantiomer mixture comprising approximately 25% S-isomer and 75% R-isomer.

For example the following attractant bouquets are suitable for attracting the Thanasimus species Thanasimus femoralis Z.:
a.8 ipsdienol+ipsenol,
a.9 cis-verbenol.

For example the following attractant bouquets are suitable for attracting the Thanasimus species Thanasilmus undatulus:
a.10 frontalin+seudenol,
a.11 seudenol+α-pinene,
a.12 verbenol.

Particularly suitable for attracting Nemosoma species is an attractant, or attractant bouquet, which comprises at least one of the following substances: cis-verbenol, 3R,6R-vittatol, chalcogran or bicolorin. In addition, these attractant bouquets may also comprise one or more further, for example 1, 2 or 3, attractant substances such as grandisol, methylbutenol, methylbutynol and/or methyl (2E,4Z)-2,4-decadienoate. For example the following attractant bouquets are suitable for attracting Nemosoma species:
b.1 chalcogran (ethyl-1,6-dioxaspiro[4,4]nonane)+methylbutenol or methylbutinol+methyl (2E,4Z)-2,4-decadienoate (Chalcoprax®),
b.2 cis-verbenol+grandisol,
b.3 bicolorin ((1S,2R,5R)-2-ethyl-1,5-dimethyl-6,8-dioxabicyclo(3.2.1)octane) and
b.4 vittatol.

Application of the attractant, or attractant bouquet, for attracting the predators is effected in a manner known per se using dispensers which ensure uniform release of the attractant, or attractant bouquet, to the environment. These are, as a rule, small plastics containers, for example vials or film bags made of plastics materials which comprise the attractant(s), the attractant(s) diffusing across the wall materials of the container and thus being released uniformly into the environment. Such attractant-comprising containers are known well to the skilled worker and commercially available, for example under the trade names Pheroprax, Typosan, Ipsowit, Chalcosan, Chalcoprax, Chalcowit, Cemsan, Cembräwit, Trypowit, Linoprax and the like.

These devices are, naturally, placed in locations where control of the bark-beetle population is intended, for example in forest regions with windbreak, south-west-facing slopes, stands with existing bark-beetle infestation or where stages of damaged timber exist in the provision of dead timber, and in timber stores.

To this end, it will generally, depending on the size of the area to be protected and the amount and distribution of the undressed timber to be protected, suffice to place one or more attractant-comprising containers at those locations where the bark-beetle population is to be controlled. Constructions and filling volumes of current dispensers/vials are possible for this purpose. Since, however, the aggregation of the predators is to take place everywhere on the objects to be protected, i.e. not localized in traps, as has previously been the case, and since the effect only needs to last for the control period required, several smallish dispensers/vials with a duration of action of 30 up to 120 days should suffice. However, dispensers/vials with longer durations of action of more than 30 days, for example with durations of actions of up to 2 or 3 months, can, naturally, also be employed.

The predators can be attracted at a point in time at which attack by bark beetles is already noticeable. However, the predators will advantageously be attracted at a point in time at which attack by the potentially harmful bark-beetle species has not yet set in (prophylactically). In this manner, attack can largely be prevented, or at least be markedly reduced, without the use of a plant protectant being required. The point in time at which such an attack by beetles can be expected can be predicted by the skilled worker with sufficient accuracy. Technical support by commercially available monitoring methods using bark-beetle pheromones would also be possible for this purpose.

The attractant will advantageously be selected in such a way that it brings about, at the location where the bark-beetle population is to be controlled, selective attraction of the predators in question.

In accordance with a first embodiment of the method according to the invention, an attractant bouquet which is known to attract bark beetles extraneous to the habitat is used. In other words, an attractant, or an attractant bouquet, is used which is suitable for attracting those bark beetles which are not indigenous at the location where control is desired. This is because it has emerged, surprisingly, that predators of bark beetles which are indigenous to the habitat in question can also be attracted specifically by those attractants, or attractant bouquets, which are characteristic of bark beetles which are not indigenous to the habitat to be controlled. For example, it is possible to use attractants, or attractant bouquets, of bark beetles of spruce on objects to be protected, for example undressed timber, dead timber or trees, which do not consist of untreated spruce timber or dead spruce timber and which are not located in spruce wood. In the same manner, this effect can also be exploited for protecting other tree species, for example pines, larches, firs, oaks, beeches and the like.

A further possibility of selective attraction consists in using an attractant or attractant bouquet, which only comprises some of the components which are characteristic of the attractant bouquet of the bark beetle species to be controlled. To attract the predators of bark beetles, only one, two or three of the components of an attractant bouquet which is characteristic of a bark-beetle species should thus suffice for sufficiently attracting the respective predators of this bark-beetle species. As the result of the absence of one or more of the components which are specific for the bark-beetle species, these attractants, or attractant bouquets, bring about no attraction, or only a minor degree of attraction, of the bark beetles to be controlled even in habitats of those bark beetles from whose attractant bouquet the components were derived. Moreover, the recombination of constituents of known attractants of one bark-beetle species, and the recombination of components of the attractants of a variety of bark-beetle species, should make possible the increased aggregation of one predator, or the targeted simultaneous aggregation of a plurality of predators.

Table 2 shows a list of bark-beetle species, their predators and the attractant bouquets which are possible for selectively attracting the predators.

TABLE 2
Selected bark-beetle species, their main predators, and the predator
attractant bouquets which are possible

| | | Selective |
|---|---|---|
| Bark-beetle species | Predator | attractant(s) |
| Ips typographus | Thanasimus formicarius | a.2, a.3, a.4 |
| Pityogenes chalcographus | Nemosoma elongatum | b.2, b.3 |
| Large larch bark beetle | Thanasimus formicarius | a.1, a.2, a.3 |
| Ips stenographus | Thanasimus formicarius | a.1, a.3, a.4 |
| Sharp-dentated bark beetle | Thanasimus formicarius | a.1, a.3, a.4 |
| Two-toothed pine beetle | Nemosoma elongatum | b.1, b.3 |
| Taphrorychus bicolor | Nemosoma elongatum | b.1, b.2 |
| Pine-shoot beetle | Thanasimus formicarius | a.1, a.3, a.4 |
| Dendroctonus spp. | Thanasismus dubius | a.5, a.6, a.7 |
| Ips grandicollis | Thanasismus dubius | a.5, a.6, a.7 |
| Ips avulsus | Thanasismus dubius | a.5. a.6. a.7 |
| Ips calligraphus | Thanasismus dubius | a.5, a.6, a.7 |
| Ips pin | Thanasismus dubius | a.5, a.6, a.7 |

The examples which follow are intended to further illustrate the invention and are not to be construed as limiting.

Theysohn® bark-beetle slot traps were operated in 2003 in spruce stands of the lowland plain in North East Germany (Land Brandenburg, Forest Agency Lübben, Forestry District Baruth, Radeland Division). The modification of these traps consisted in sealing the water drips and filling the trap container with an insect-preserving fluid without attractant effects. In this manner, no trapped organisms could escape from the traps and be identified unharmed. The baits used were commercially available Pheroprax® and Chalcoprax®) dispensers. The traps were operated from 04.13.2003 to 08.29.2003.

As a result, a total of 873 Thanasimus formicarius and 2815 Thanasimus rufipes were trapped in the four Pheroprax® traps, and 109 Nemosoma elongatum and 311 specimens from the family Staphilinidae were caught in the four Chalcoprax® traps.

However, among the bark beetles of the species Tomicus piniperda, Tomicus minor, Ips sexdentatus and Ips acuminatus, which are always present are to be expected in spruce woods and which belong to the prey profile of the Thanasimus species in spruce woods, the Pheroprax® traps only revealed a total of only 20 Ips acuminatus and 11 Hylastes angustatus and 4 Hylastes ater, whose occurrence on live trees and undressed timber is insignificant. Moreover, 127 Ips typographus were found; these may originate from spruce timber of a wood processing plant nearby and are generally not capable of populating Picea abies trees or undressed timber.

Not a single specimen of Pityogenes bidentatus, which is always present and to be expected in spruce woods and which is a typical prey insect for Nemosoma elongatum in spruce forests, was found in the Chalcoprax® traps. Of other bark beetles which attack spruce, only 16 Hylastes angustatus, 12 Hylastes ater, one Tomicus piniperda and 3 Ips acuminatus were found. 18 526 specimens, a number of Pityogenes chalcographus which was hitherto unheard of for spruce forests, were also found; while they are as yet not known as having harmful effects in spruce forests, the distance to the wood processing plant would indicate that the undressed spruce timber processed therein would be unlikely to be their origin.

These results demonstrate that the attractants of bark beetles which usually occur on Picea abies make it possible to aggregate the predators of pine-atacking bark beetles in pine forests without simultaneously attracting the indigenous pine-attacking bark beetles. The low unwanted catches of pine-attacking bark beetles and spruce-attacking bark beetles are entirely insignificant for Scotch pine trees and undressed Scotch pine timber, in terms of both number and species composition.

1-7. (canceled)

8. A method of controlling populations of bark beetles (Scolytidae) comprising:
applying at least one predator attractant of the bark beetles;
wherein the at least one predator attractant applied differs from the aggregation pheromone bouquet of the bark beetle species to be controlled;
wherein the population of bark beetles is controlled.

9. The method according to claim 8, wherein the at least one predator attractant corresponds to the pheromone bouquet of a bark beetle species which is non-endemic to the habitat.

10. The method according to claim 8, wherein the at least one predator attractant comprises only part of the characteristic components of the aggregation pheromone bouquet of the bark beetle species to be controlled.

11. The method according to claim 8, wherein the at least one predator attractant is applied before or during a bark-beetle attack.

12. The method according to claim 9, wherein the at least one predator attractant is applied before or during a bark-beetle attack.

13. The method according to claim 10, wherein the at least one predator attractant is applied before or during a bark-beetle attack.

14. The method according to claim 8, wherein the predator attractant comprises at least one attractant component of the aggregation pheromone bouquet of the bark beetle species to be controlled.

15. The method according to claim 9, wherein the predator attractant comprises at least one attractant component of the aggregation pheromone bouquet of the bark beetle species to be controlled.

16. The method according to claim 10, wherein the predator attractant comprises at least one attractant component of the aggregation pheromone bouquet of the bark beetle species to be controlled.

17. The method according to claim 11, wherein the predator attractant comprises at least one attractant component of the aggregation pheromone bouquet of the bark beetle species to be controlled.

18. The method according to claim 8, wherein the predator attractant is selected from the group consisting of beetles (Coleoptera) from the families Cleridae.

19. The method according to claim 18, wherein the predator attractant is selected from the group consisting of the genus Thanasimus and Ostomidae.

20. The method according to claim 18, wherein the predator attractant is selected from the group consisting of the genus Nemosoma, Staphilinidae and Rhizophagidae.

21. The method according to claim 8, wherein the predator attractant comprises at least one of the following components selected from the group consisting of ipsdienol, verbenol, lineatin, 3R,6R-vittatol, seudenol, lanierone, frontalin, alpha-pinene, chalcogran, bicolorin and their isomers.

22. The method according to claim 9, wherein the predator attractant comprises at least one of the following components selected from the group consisting of ipsdienol, verbenol, lineatin, 3R,6R-vittatol, seudenol, lanierone, frontalin, alpha-pinene, chalcogran, bicolorin and their isomers.

23. The method according to claim 10, wherein the predator attractant comprises at least one of the following components selected from the group consisting of ipsdienol, verbenol, lineatin, 3R,6R-vittatol, seudenol, lanierone, frontalin, alpha-pinene, chalcogran, bicolorin and their isomers.

24. The method according to claim 18, wherein the predator attractant comprises at least one of the following components selected from the group consisting of ipsdienol, verbenol, lineatin, 3R,6R-vittatol, seudenol, lanierone, frontalin, alpha-pinene, chalcogran, bicolorin and their isomers.
